(19) United States
(12) Patent Application Publication
(10) Pub. No.: US 2008/0239560 A1
(43) Pub. Date: Oct. 2, 2008

(54) MAGNETIC DEVICE AND METHOD OF CONTROLLING MAGNETIC DEVICE

(75) Inventors: Ken Yakuwa, Kawasaki (JP); Tsuyoshi Takahashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/021,468

(22) Filed: Jan. 29, 2008

(30) Foreign Application Priority Data
Mar. 27, 2007 (JP) 2007-082101

(51) Int. Cl. G11B 5/584

(52) U.S. Cl. 360/77.14

(57) ABSTRACT

According to an aspect of an embodiment, a magnetic device comprises a head for writing data into or reading data from a medium, the head having an actuator for changing a flying height of the head over the medium, a storage for storing characteristic information of areas of the medium and a controller for controlling the actuator on the basis of the characteristic information of the areas of the medium when writing data into or reading data from the areas of the medium.

### BACKGROUND

1. Field

The present technique relates to a method for controlling a levitation value of a head with respect to a storage medium.

2. Description of the Related Art

Examples of the related art pertaining to the technique of controlling a levitation value of a head include Japanese Unexamined Patent Application Publication Nos. 05-20635 and 2006-24289.

### SUMMARY

According to an aspect of an embodiment, a magnetic device comprises a head for writing data into or reading data from a medium, the head having an actuator for changing a flying height of the head over the medium, a storage for storing characteristic information of areas of the medium and a controller for controlling the actuator on the basis of the characteristic information of the areas of the medium when writing data into or reading data from the areas of the medium.

### BRIEF DESCRIPTION OF DRAWINGS

FIG. 1 is a block diagram showing a basic structure of one example of a storage unit of embodiments;

FIG. 2 is a diagram showing an RDC and a pre-amp IC together with an internal structure of a magnetic head;

FIG. 3 is a section view of the magnetic head;

FIG. 4 is a graph showing a relationship of heater electric current and heater electric power when a resistance value of a heater is 100Ω;

FIG. 5 is a graph showing a relationship of the heater electric current and an expansion of the magnetic head;

FIG. 6 is a graph showing a relationship between a levitation value of the magnetic head and a SN ratio;

FIG. 7 is a graph showing a relationship of the SN ratio and an error rate;

FIG. 8 is a chart showing dispersion of coercive force of a magnetic storage medium;

FIG. 9 is an enlarge view of part of the magnetic head and the magnetic disk;

FIG. 10 is a (first) flowchart of a process for preparing a table showing a relationship of each sector in a circumferential direction and the heater electric current;

FIG. 11 is a (first) graph showing information of correspondence between each sector in the circumferential direction and the error rate;

FIG. 12 is a (first) detailed flowchart of a process for calculating a required heater electric current in each sector in a circumferential direction;

FIG. 13 is a (first) table showing the relationship between each sector in a circumferential direction and the heater electric current;

FIG. 14 is a flowchart explaining operations of the exemplary embodiment;

FIG. 15 is a (second) flowchart of a process for preparing a table showing a relationship of each sector in a circumferential direction and the heater electric current;

FIG. 16 is a graph showing information of correspondence between each sector in a circumferential direction and an overwrite characteristics;

FIG. 17 is a (second) detailed flowchart of a process for calculating a required heater electric current in each sector in the circumferential direction;

FIG. 18 is a graph showing a relationship between a levitation value of the magnetic head and the overwrite characteristics;

FIG. 19 is a (second) table showing the relationship between each sector in a circumferential direction and the heater electric current;

FIG. 20 is a (second) graph showing information of correspondence between each sector in the circumferential direction and the error rate; and

FIG. 21 is a (third) table showing the relationship between each sector in a circumferential direction and the heater electric current.

### DESCRIPTION OF THE PREFERRED EMBODIMENTS

A magnetic disk unit (HDD: Hard Disk Drive) is mounted in various products such as desktop personal computers, notebook type personal computers, servers, navigation apparatuses and AV (Audio Visual) machines. With a demand on increase of a storage capacity of the HDD, it has been required to increase recording density of a magnetic disk. It is necessary to narrow gaps between bits of the magnetic disk to increase signals that can be recorded in order to increase the recording density.

When the bit density (BPI) of the magnetic disk is increased, however, it becomes necessary to decrease a flying height of the magnetic head so that the head approaches more to the magnetic disk to write or read information.

When the levitation of the head is decreased so that the head approaches to the magnetic disk, dispersion of magnetic characteristic of the magnetic disk caused substantially in a circumferential direction affects more to performances for writing and reading information.

Specifically, the dispersion of the magnetic characteristic occurs substantially in the circumferential direction by influence and distribution of thickness of a texture formed on a surface of a substrate of the magnetic disk substantially in the circumferential direction to give a magnetic anisotropy to a magnetic layer.

Noticing on the problem caused in the magnetic disk, i.e., on the dispersion of the magnetic characteristic, the present exemplary embodiment improves the writing and reading performances by accurately controlling the levitation of the magnetic head and improves the storage capacity by increasing the density more.

The exemplary embodiment will be explained below with reference to the drawings.

### First Embodiment

### Drawing of Hardware Structure of HDD:

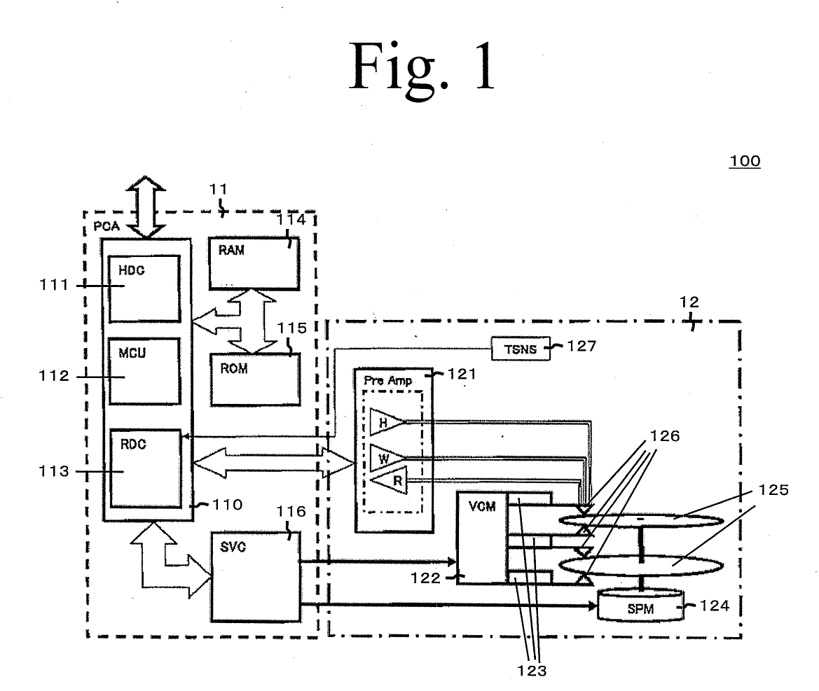

FIG. 1 is a block diagram briefly showing one exemplary hardware structure of the HDD of the present embodiment. As shown in FIG. 1, the HDD 100 is composed of a printed circuit assembly (PCA) 11 for controlling the entire HDD 100 and transmission and receiving of signals with a host unit (not shown) via a host interface and a disk enclosure (DE) 12.

The PCA 11 has a hard disk controller (HDC) 111, a micro controller unit (MCU) 112, a read channel (RDC) 113, a random access memory (RAM) 114, a read only memory (ROM) 115 and a servo combo chip (SVC) 116. The HDC 111 makes controls such as interface protocol control, data buffer control, disk format control and the like. The MCU 112 controls the HDC 111, the RDC 113 and the SVC 116 and manages memory within the HDD 100 such as the RAM 114 and the ROM 115 by carrying out arithmetic operations. The RDC 113 carries out coding and decoding that are processes for writing or reading data to/from a magnetic disk 125, i.e., a storage medium. The HDC 111, the MCU 112 and the RDC 113 compose a control section 110. The RAM 114 stores various data including intermediate data of the arithmetic operation carried out by the MCU 112. The ROM 115 stores programs and data executed by the MCU 112. The SVC 116 makes control of driving current for a voice coil motor (VCM) 122 and a spindle motor (SPM) 124 within the DE 12 on the basis of instructions from the MCU 112.

The DE 12 includes a pre-amplifier IC 121, the VCM 122, an actuator 123, the SPM 124, a magnetic disk, a magnetic head 126 and temperature sensor nodes (TSNS) 127. Although FIG. 1 shows a case provided with two magnetic disks 125 and a pair of magnetic heads 126 for each of the magnetic disk 125, the number of the magnetic disk 125 and the magnetic head 126 is not limited to the case of FIG. 1. The pre-amplifier IC 121 has a write driver 121W for amplifying a write signal to supply to the magnetic head 126, a read driver 121R for amplifying a read signal from the magnetic head 126 and a heater driver 121H for driving a heater (not shown) within the magnetic head 126 by a number N of channels corresponding to a number N of the magnetic head 126 and selectively switch their operation/non-operation. The heater is an actuator. The VCM 122 drives the actuator 123 supporting the magnetic head 126 substantially in a radial direction of the magnetic disk. The SPM 124 rotates the magnetic disk 125 by a predetermined number of revolutions. The magnetic head 126 has a write head for recording write signals to the corresponding magnetic disk 125, a read head for reading read signals from the corresponding magnetic disk 125 and a heater. The TSBS 127 is a sensor for detecting temperature within the DE 12, i.e., environmental temperature of the HDD 100, and is a thermister for example.

### Internal Structure of Magnetic Head:

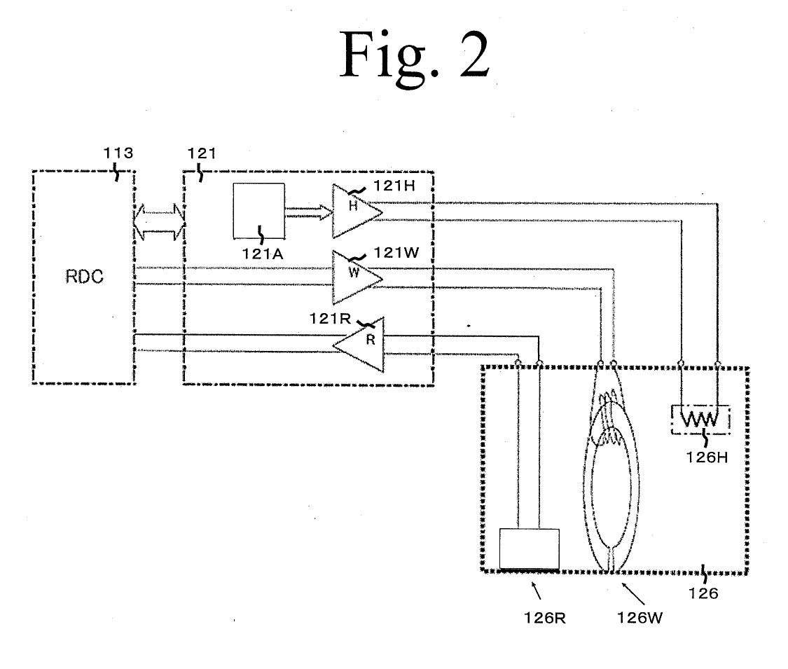

FIG. 2 is a diagram showing the RDC 113 and the pre-amp IC 121 together with an internal structure of the magnetic head 126. As shown in FIG. 2, a heater control circuit 121A is provided within the pre amplifier IC 121 and the read head 126R, the write head 126W and the heater 126H composed of a coil are provided within the magnetic head 126. The read signal read by the read head 126R from the magnetic disk 125 is amplified by the read amplifier 121 and is supplied to the RDC 113. The write head 126W receives the write signal from the RDC 113 via the write driver 121W and writes into the magnetic disk 125. A calorific value of the heater 126H is controlled by a heater control circuit 121A via a pre amplifier IC 121H. It is noted that there is a merit that the heater may be manufactured in a process of thin film magnetic head by constructing the heater 126H by the coil. The coil also has a merit that it takes only a short time until when it generates heat after flowing an electric current and that its response characteristic is good.

### Section View of Magnetic Head:

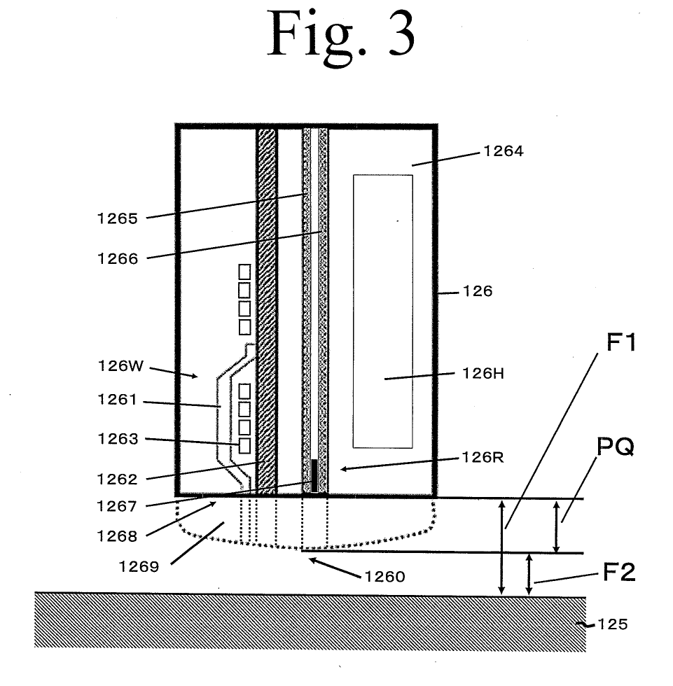

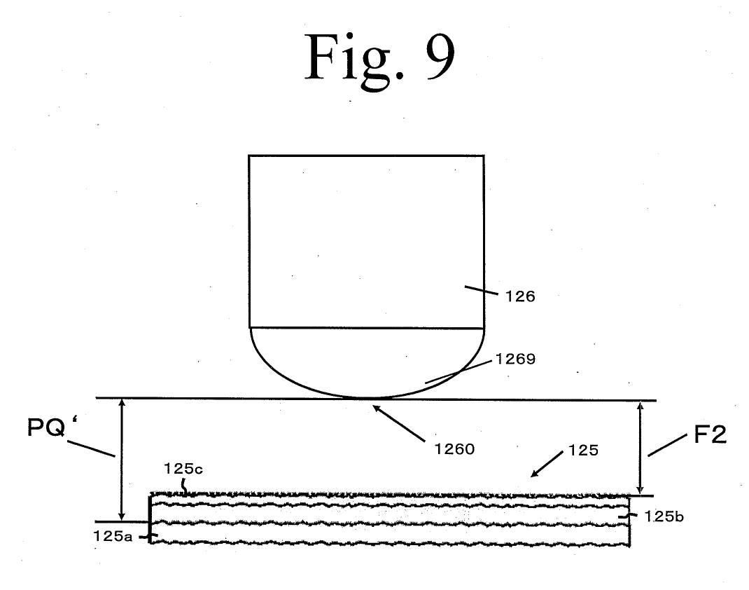

FIG. 3 is a section view showing a main part of the magnetic head 126. The 126W shown in FIG. 2 has a structure in which a coil 1263 is wound around an upper magnetic pole 1261 and a lower magnetic pole 1262 as shown in FIG. 3 for example. When electric current is supplied to the coil 1263, a magnetic field is generated in a write gap and the write signal is written to the magnetic disk 125. The 126R has a structure in which an upper shield-cum-electrode 1265 and a lower shield-cum-electrode 1266 are formed within an insulating layer using aluminum oxide Al₂O₃ known as alumina and a read element 1267 is disposed at position of a read gap of a face opposing to a medium 1268. The upper shield-cum-electrode 1265 and the lower shield-cum-electrode 1266 absorb magnetic flux other than those to be flown into the read element 1267. A resistance value of the read element 1267 changes on the basis of the magnetic flux flowing thereto. The read head 126H reads signals by utilizing the changes of the resistance value. The calorific value of the heater 126H is controlled by a heater electric current supplied thereto and corresponding to the calorific value, each section of the magnetic head 126 including a magnetic disk resin section 1264 made of an insulating material such as a ceramic material around the heater thermally expands like an expansion 1264 indicated by a dotted line in FIG. 3. This thermal expansion occurs on a levitating face of the magnetic head 126, i.e., in a direction facing to the magnetic disk 125. A value of the thermally expanded portion is called as magnetic disk expansion value (projection value). Normally, the levitation of the magnetic head 126 is kept in F1. The thermal expansion corresponding to a heater electric power occurs as shown by the dotted line in FIG. 3 by supplying the heater electric current and the expansion value PQ changes corresponding to the heater electric power. Accordingly, a spacing between an edge portion 1260 of the magnetic head 126 on the side of the medium and the medium decreases by the magnetic disk expansion value PQ and becomes F2 as shown in FIG. 3. It is noted that the spacing will be described later by using FIG. 9.

### Graphs Showing Corresponding Relationship:

Graphs showing various corresponding relationships will be explained below. Each figure is used in a process of preparing a corresponding relationship between each sector of the magnetic disk described later and divided into a predetermined number in a circumferential direction of a track of the magnetic disk and the heater electric current in each sector.

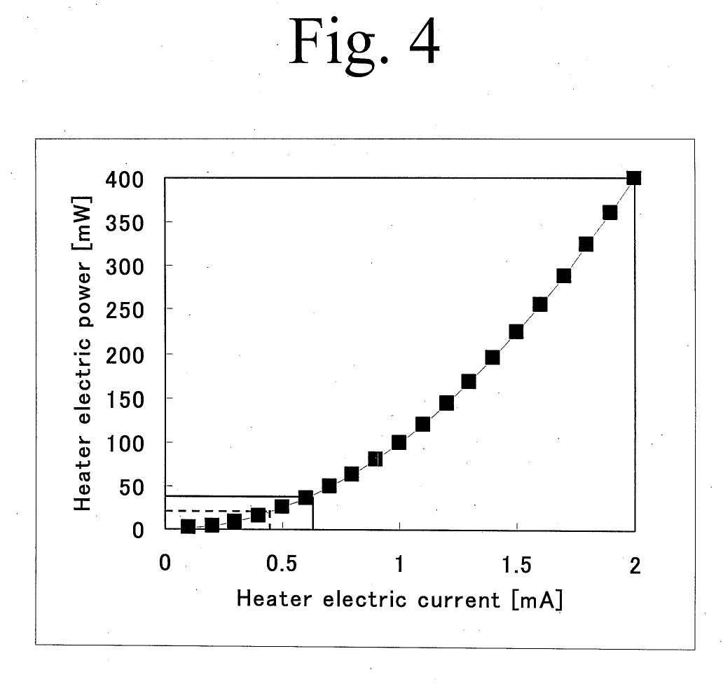

FIG. 4 is a graph showing the corresponding relationship of the heater electric current and the heater electric power when a resistance value of the heater 126H is 100Ω.

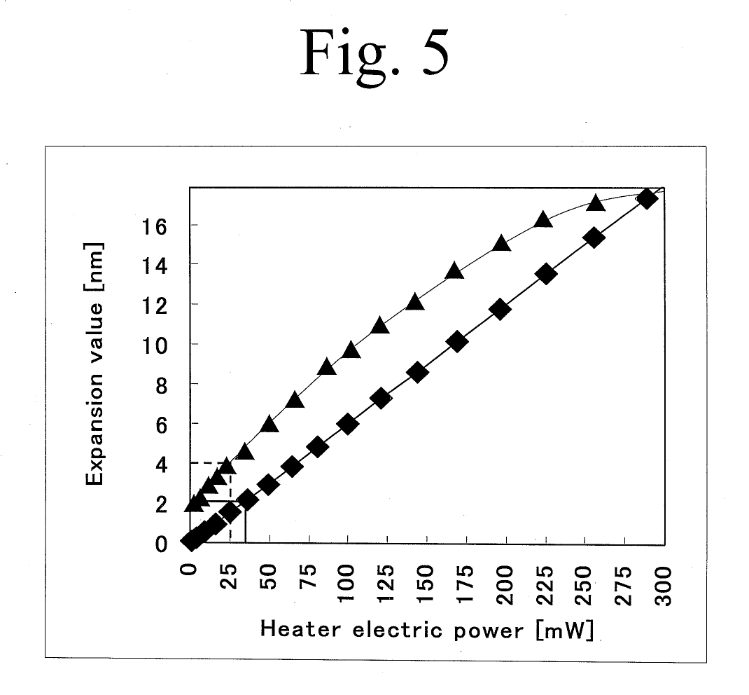

FIG. 5 is a graph showing a relationship of the heater electric current and the magnetic disk expansion value. Points plotted by squares indicate the relationship between the heater electric power and the magnetic head expansion value when a read operation is carried out in the magnetic disk. Meanwhile, points plotted by triangles indicate the relationship between the heater electric power and the magnetic head expansion value when a write operation is carried out in the magnetic disk. A reason why the corresponding relationship of the write operation is different from that when the read operation is carried out is because electric current is supplied to the write coil when the write operation is carried out and because the magnetic disk expands by the both heats generated by the write coil and generated by the heat.

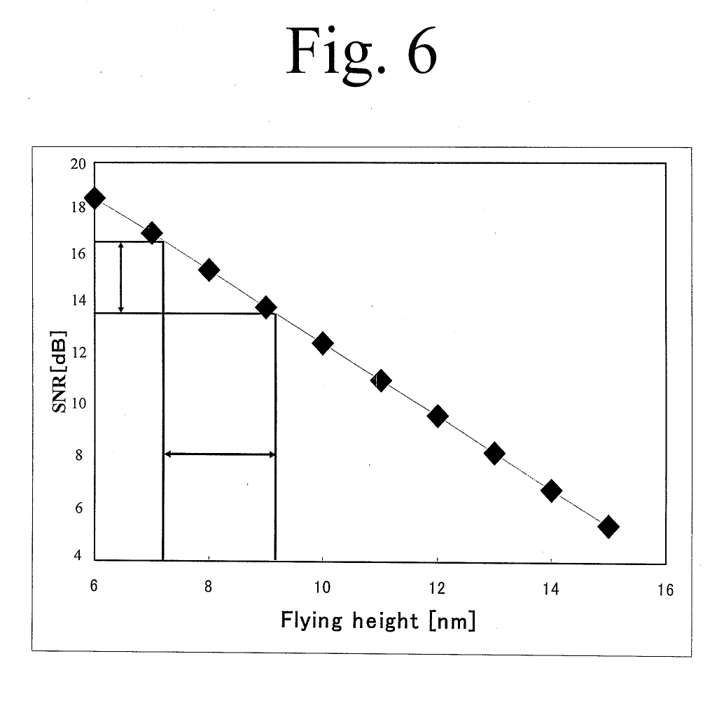

FIG. 6 is a graph showing a relationship between a levitation value of the magnetic head and a SN ratio (signal to noise ratio) of the read signal read from the read head 126R when the magnetic head levitation value changes. As it is apparent from FIG. 6, the higher the magnetic head levitation value, the lower the S/N ratio becomes and the lower the magnetic head levitation value, the higher the S/N ratio, improving the signal quality.

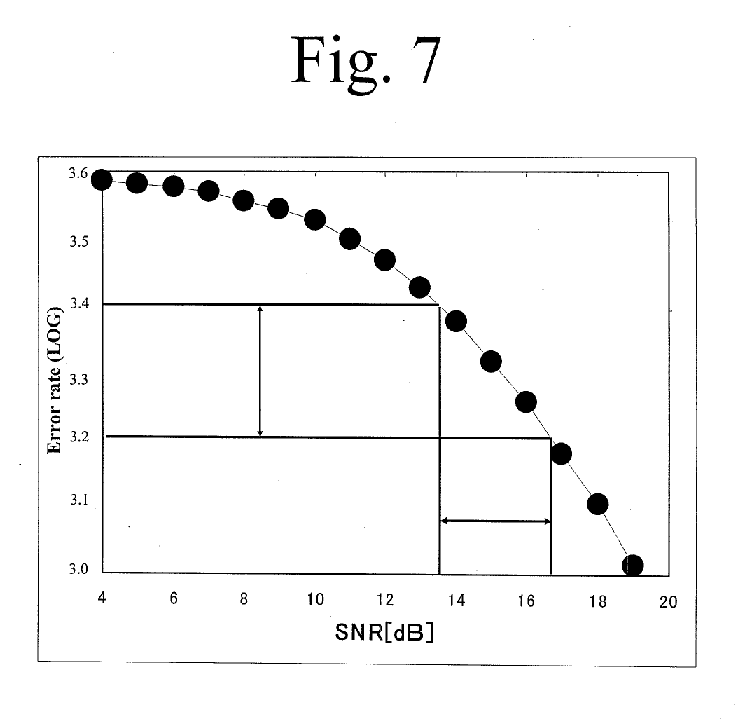

FIG. 7 is a graph showing a relationship between the SN ratio and an error rate. The error rate is a rate of a number of times when test data is not correctly read with respect to a number of written times when the test data is read after writing the test data to the magnetic disk. As it is apparent from FIG. 7, the error rate decreases when the S/N ratio is high, i.e., the magnetic head levitation value decreases. As a result, the error rate of the read signal drops, improving the signal quality. The error rate increases when the S/N ratio drops, i.e., the magnetic head levitation value increases on the other hand. As a result, the error rate of the read signal increases, lowering the signal quality.

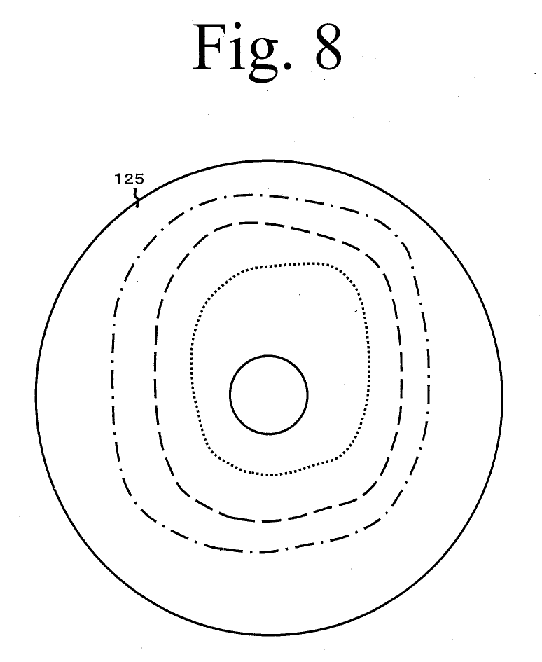

FIG. 8 is a chart showing dispersion of coercive force of a magnetic storage medium. It shows values of equal coercive force by a pattern of contour lines. A dotted chain line or a dotted line shows distribution of values of equal coercive force. When the coercive force thus disperses, it affects the S/N ratio on the same circumference. The dispersion of the coercive force is also caused by dispersion of thickness in fabricating the magnetic storage medium. The magnetic storage medium is constructed by sequentially laminating a base film, a magnetic film (recording film), a protection film and a lubricant film on a substrate such as glass and aluminum. The dispersion of the thickness of the magnetic disk becomes significant when the levitation value of the magnetic head decreases and it largely depends on the thickness of the protection and lubricant films in particular. The thickness of the protection film is 4.0 nm for example and that of the lubricant film is 1.0 nm for example. The dispersion of the thickness of the lubricant and protection films changes a gap between the recording film of the magnetic storage medium and the magnetic head and affects the S/N ratio described above. When the thickness of the protection film fluctuates in a range of ±0.5 nm for example, the S/N ratio fluctuates in a range of ±0.3 dB.

FIG. 9 is an enlarge view of part of the magnetic head 126 and the magnetic disk 125. As shown in FIG. 9, the magnetic disk 125 has a structure in which the protection film 125b is laminated on a surface of the recording film 125a composed of a single layer or a multiple layer formed by overlapping on the base film on the substrate made of textured aluminum or the like and the lubricant film 125c is laminated on the surface of the protection film 125b. Because the substrate is textured, boundaries between the respective layers are not also completely smooth and very small irregularities are seen also on the surface of the magnetic disk 125 as shown in FIG. 9. Here, while the distance F2 between the edge portion 1260 and the surface of the magnetic disk 125 explained in FIG. 3 has been defined as the spacing, a distance PQ′ between the edge portion 1260 and the recording film 125a will be defined as a magnetic spacing. As explained in FIG. 8, the texture of the substrate formed substantially in the circumferential direction is thought to be affecting the magnetic characteristics such as the coercive force why it disperses approximately in the circumferential direction.

### Overall Flow of Process for Preparing Table:

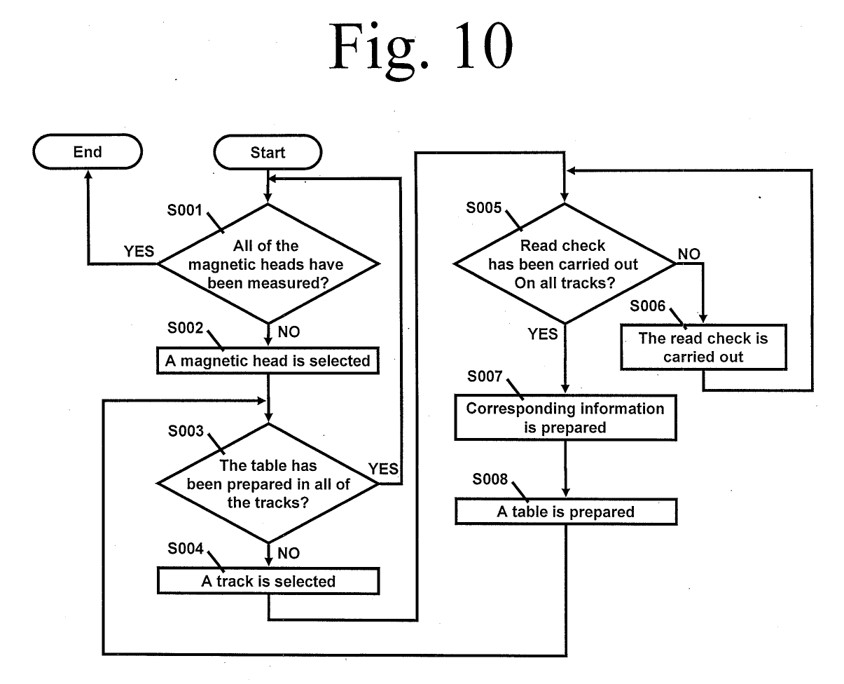

A process for preparing a table that correlates the sector of the track and the heater electric current will be explained below by using FIG. 10. The table is prepared for cases when internal temperature of the HDD is low (0° C.), normal (40° C.) and high (60° C.). It is because the characteristics of the magnetic head is influenced by an environment in which the HDD is used. It is noted that the table is prepared in unit of each magnetic head and the track of the storage medium corresponding to each magnetic head and each magnetic head. This process for preparing the table is carried out in a fabrication process for example.

In Step S001, it is judged whether or not all of the magnetic heads have been measured. When all of the magnetic heads have not been measured, the process shifts to Step S200.

In Step S002, a magnetic head to be measured is selected. The process then shifts to Step S003.

In Step S003, it is judged whether or not the table has been prepared in all of the tracks on the magnetic disk 125. When the table has not been prepared in all of the tracks, the process shifts to Step S004.

In Step S004, a track to be measured is selected. The process then shifts to Step S005.

In Step S005, it is judged whether or not the read check has been carried out on all of the sectors of the track selected in Step S004. When the read check has been carried out on all of the sectors, the process shifts to Step S007. When the read check has not been carried on all of the sectors on the other hand, the process shifts to Step S006.

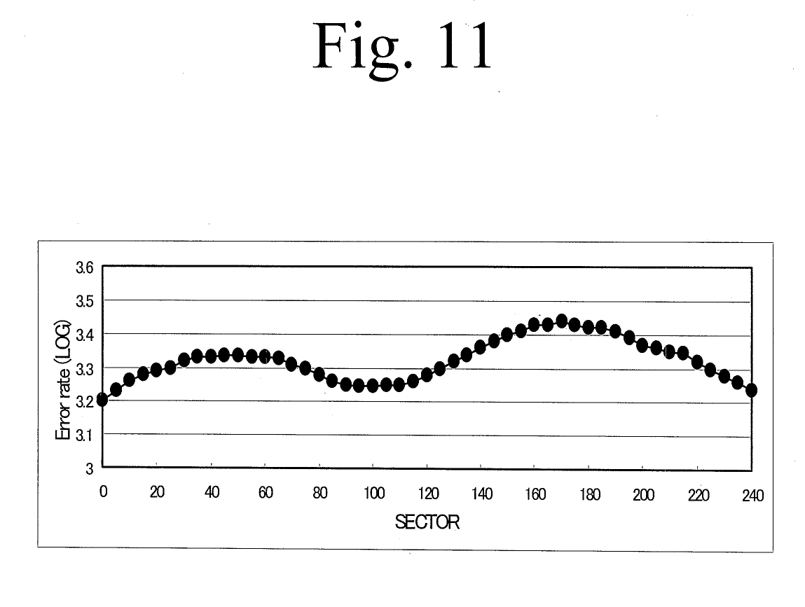

In Step S006, the read check is carried out. The read check is carried out by writing test data to the magnetic disk by the write head of the magnetic head 126 and by reading the written test data by the read head of the magnetic head 126. This read check is carried out in each sector in each track. When the read check has been carried out on all of the sectors, the process shifts to Step S007 or corresponding information of a sector and the error rate in a certain track is prepared. FIG. 11 shows the corresponding information of the error rate and the sector in the certain track. The process then shifts to Step S008.

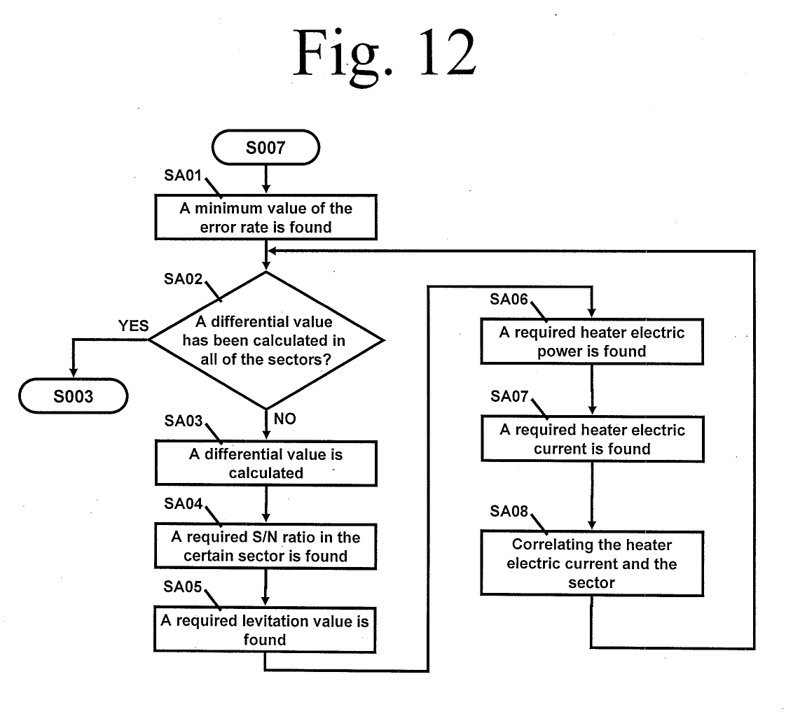

In Step S008, a table indicating the sector and the heater electric power in the certain track of the certain magnetic head is prepared based on the corresponding information prepared in Step S007. The process in Step S008 will be explained in detail by using FIG. 12.

### First Detailed Flow of Process for Preparing Table:

In Step SA01, a minimum value of the error rate is found from the corresponding information created in Step S007. It is noted that the levitation value of the magnetic head when the error rate is minimum is a reference levitation value. Then, the process shifts to Step SA02.

In Step SA02, it is judged whether or not a differential value between the value of error rate and the minimum value of the error rate found in Step SA01 has been calculated in all of the sectors. When the differential value has been calculated in all of the sectors, the process shifts to Step S003 in FIG. 10. When the differential value has not been carried out for all of the sectors on the other hand, the process shifts to Step SA03.

In Step SA03, a differential value between the value of error rate of a certain sector and the minimum value of the error rate found in Step SA01 is calculated. It is noted that the calculation of the differential value may be carried out in order from a sector whose number is small. Then, the process shifts to Step SA04.

In Step SA04, a required S/N ratio in the certain sector is found from the differential value of the error rate calculated in Step SA01 and the corresponding relationship between the error rate and the S/N ratio explained by using FIG. 7. The minimum value of the error rate is “3.2” in FIG. 11 for example. Assume now to calculate a difference with a sector whose error rate is “3.4”. The S/N ratios corresponding to error rates of “3.2” and “3.4” are “16.5” and “13.7”, respectively, in FIG. 7. Then, the process shifts to Step SA06.

In Step SA05, a required levitation value is found from the required S/N ratio found in Step SA04 and the corresponding relationship of the S/N ratio and the magnetic head levitation value explained by using FIG. 6. Then, the required S/N ratio is “2.8”. The levitation values corresponding to the S/N ratios of “16.5” and “13.7” are “7.2” and “9.2” respectively in FIG. 6 and the levitation value of the magnetic head may be decreased by “2.0” further. Then, the process shifts to Step SA06.

In Step SA06, a required heater electric power may be found from the difference of the required levitation value found in Step SA05 and the corresponding relationship of the expansion value of the magnetic head and the heater electric power explained by using FIG. 5. Here, the expansion value of the magnetic head to be expanded is “2.0”, so that the heater electric power necessary for expanding the magnetic head by “2.0” may be found to be 30 mW from FIG. 5. It is noted that a required heater electric power in a case when the write current is supplied to the magnetic head is also found in Step SA06 as explained in FIG. 5. The process then shifts to Step SA07.

In Step SA07, a required heater electric current is found from the required heater electric power found in Step SA06 and the corresponding relationship of the heater electric power and the heater electric current explained by using FIG. 4. Because the necessary heater electric power is 30 mW, the heater electric current is 0.65 mA. The process shifts to Step SA08.

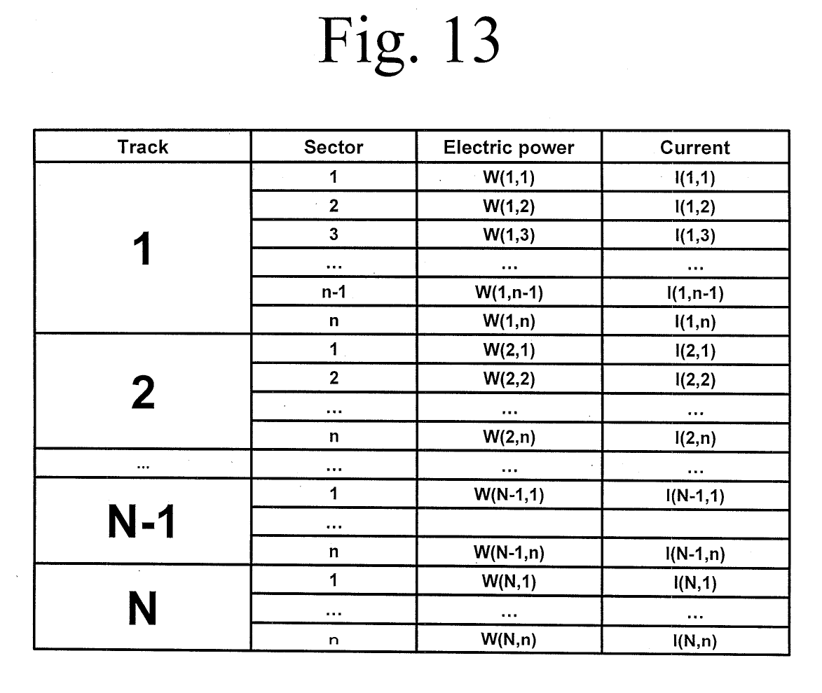

In Step SA08, a table correlating the heater electric current found in Step SA07 and the sector is prepared. FIG. 13 shows the table correlating the heater electric current and the sector. It is found from the table that in the sector 2 of the track 2, electric current I (2, 2) may be supplied to the heater to set the power W (2, 2). The process then returns to Step SA02. Thus, the table correlating each sector in a certain track with the heater electric power in each sector may be prepared. It is noted that the table is prepared for the both cases of reading and writing as explained in Step SA05. When a table correlating a sector and an error rate is prepared for a certain track, the process returns to Step S003 to prepare a table for the next track.

When it is judged that the tables have been prepared in all of the tracks on the magnetic disk 125 in Step S003, the process returns to Step S001 to carry out the process described above for the remaining magnetic head to prepare tables.

The tables correlating the heater electric current and the sector are prepared for all of the tracks of the magnetic disk for each head of the magnetic disk unit as described above. Then, these tables are stored in the storage sections such as the ROM and the magnetic disk.

### Overall Flow of Process for Controlling Levitation Value:

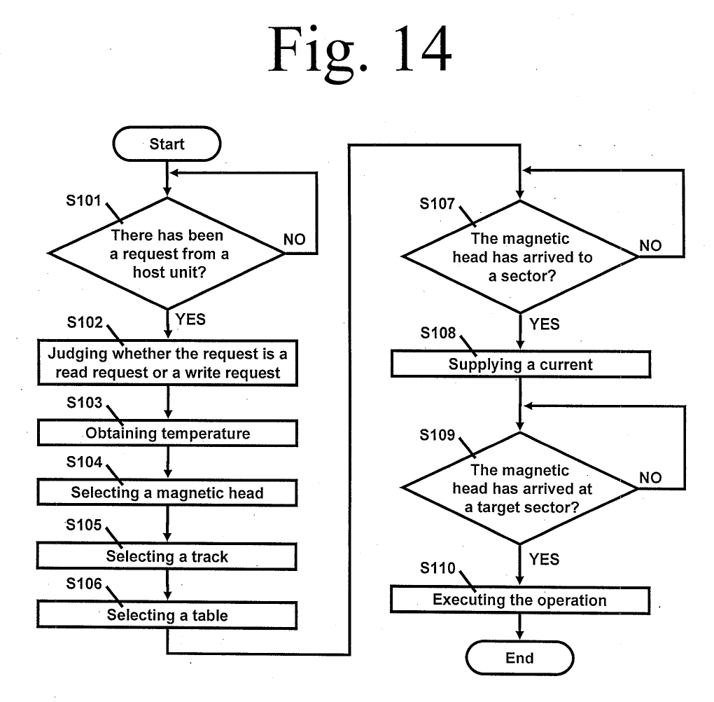

A process for controlling the levitation value of the magnetic head to the magnetic disk based on the control values of the tables prepared in the abovementioned processes will be explained below by using FIG. 14. A sector is used as a unit of correcting the levitation value of the magnetic head in the present embodiment.

In Step S101, the control section 110 judges whether or not there has been a request of write or read from a host unit via the host interface. It is noted that when there is a request from the host unit, the control section 110 stores the request in the RAM 114. Where there is the request from the host unit, the process shifts to Step S102.

In Step S102, the control section 110 judges whether the request from the host unit is a read request or a write request. Because the magnetic head expands when the request is a write request by supplying the current to the coil as described above, the table in writing is selected in Step S106 described later. Then, the process shifts to Step S103.

In Step S103, the control section 110 obtains temperature within the magnetic disk unit via the TSBS 127. It is because the relationship between the heater electric power and the thermal expansion value differs depending on the temperature within the magnetic disk unit. The process shifts to Step S104.

In Step S104, the control section 110 selects a magnetic head based on the request from the host unit. Then, the control section 110 passes information of the selected magnetic head to the SVC 116. The SVC 116 controls the actuator 123 based on the received information of the magnetic head. The process shifts to Step S105.

In Step S105, the control section 110 selects a track based on the request from the host unit. Then, the control section 110 passes information of the selected track to the SVC 116. Then, the SVC 116 controls the actuator 123 and the SPM 124 based on the received information of the track. The process shifts to Step S106.

In Step S106, the control section 110 selects a table from the RAM 114 based on the processes from Step S102 through Step S105. The table is stored in the magnetic disk and the control section 110 reads it to the RAM 114 when the magnetic disk unit is activated. The process shifts to Step S107.

In Step S107, the control section 110 judges whether or not the magnetic head has arrived to a sector before a certain number of sectors from a target sector. It takes time until when the magnetic head expands after supplying current to the heater. Therefore, the current is supplied to the heater when the magnetic head arrives at the sector before the certain number of sectors from the target sector to which the read or write operation should be carried out. The certain number of sectors is stored in the magnetic disk as a parameter and the control section 110 reads it to the RAM 114 when the magnetic disk unit is activated. It is noted that the control section 110 judges whether the magnetic head has arrived at the sector before the certain number of sectors from the target sector by obtaining information on position of the magnetic head from the SVC 116. Then, the process shifts to Step S108.

In Step S108, the control section 110 supplies the current to the heater 126H of the magnetic head based on the table. Specifically, the control section 110 passes information of the current to be supplied to the heater control circuit 121A at first. Then, based on the information, the heater control circuit 121A supplies the current to the heater 126H via the heater driver 121H. The process then shifts to Step S109.

In Step S109, the control section 110 judges whether or not the magnetic head has arrived at the target sector by comparing information related to the request from the host unit stored in the RAM 114 and the information on the position of the magnetic head obtained from the SVC 116. When the magnetic head has arrived at the target sector, the process shifts to Step S110.

In Step S110, the control section 110 executes the read or write operation based on the information on the request from the host unit stored in the RAM 114. Then, the process ends.

Thus, it is possible to expand the magnetic head in a sector whose error rate is high on the same track. Therefore, it is possible to lower the levitation value of the magnetic head and to improve the S/N ratio in the sector whose error rate is high.

### Second Embodiment

The levitation value has been controlled based on the error rate calculated by writing the test data to the magnetic disk by the write head of the magnetic head 126 and by reading the written data by the read head of the magnetic head 126 in the first embodiment. Therefore, the calculated error rate is what generally evaluates the write and read performances. A case of controlling the levitation value based on an overwrite characteristic that evaluates the write performance in writing will be explained in a second embodiment.

### Second Overall Flow of Process for Preparing Table:

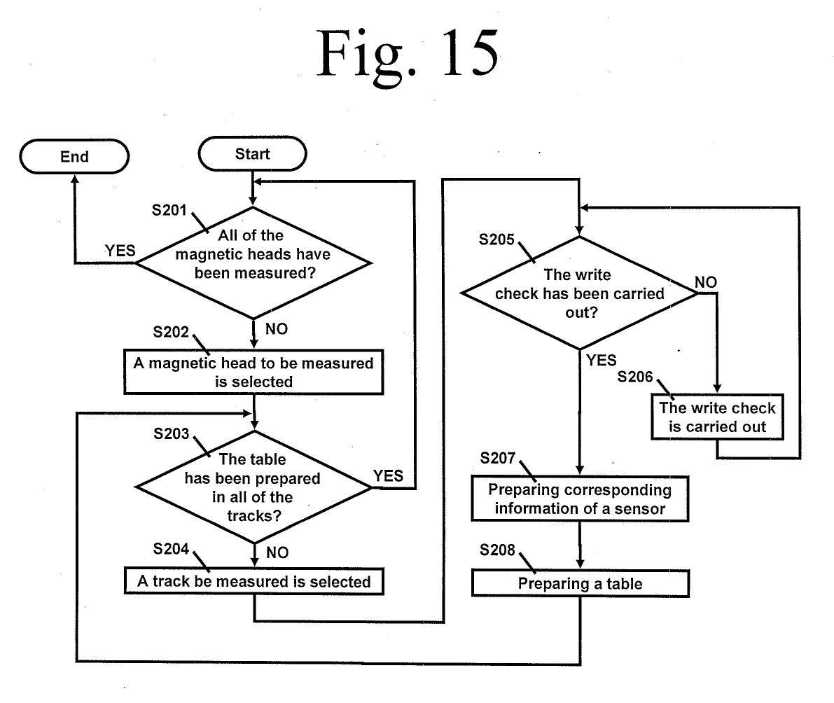

A process for preparing a table that correlates the sector of the track and the heater electric current will be explained below by using FIG. 15.

In Step S201, it is judged whether or not all of the magnetic heads have been measured. When all of the magnetic heads have not been measured, the process shifts to Step S202.

In Step S202, a magnetic head to be measured is selected. The process then shifts to Step S203.

In Step S203, it is judged whether or not the table has been prepared in all of the tracks on the magnetic disk 125. When the table has not been prepared in all of the tracks, the process shifts to Step S204.

In Step S204, a track to be measured is selected. The process then shifts to Step S205.

In Step S205, it is judged whether or not the write check has been carried out on all of the sectors of the track selected in Step S204. When the write check has been carried out on all of the sectors the process shifts to Step S207. When the write check has not been carried on all of the sectors on the other hand, the process shifts to Step S206.

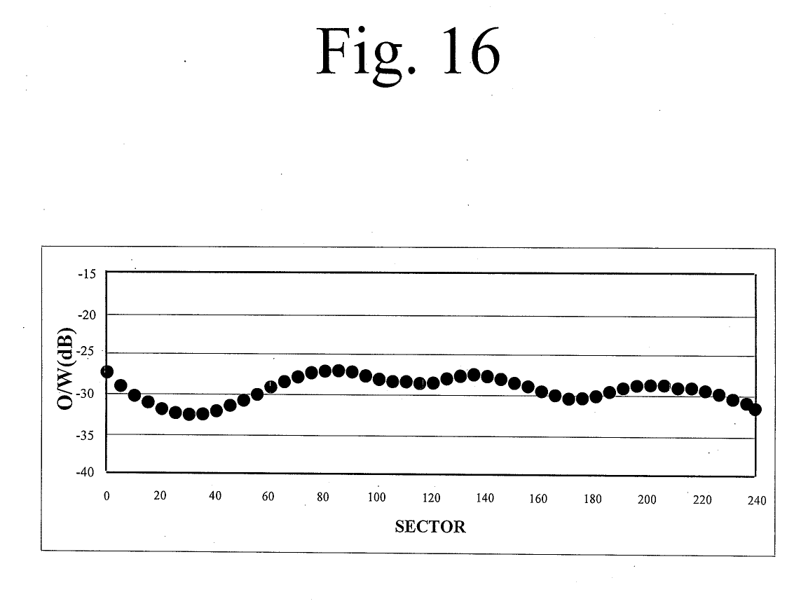

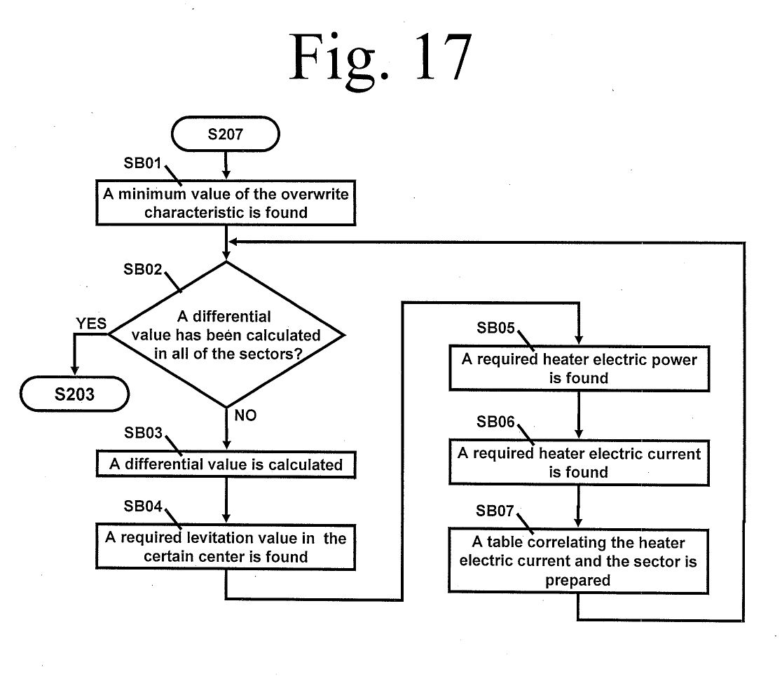

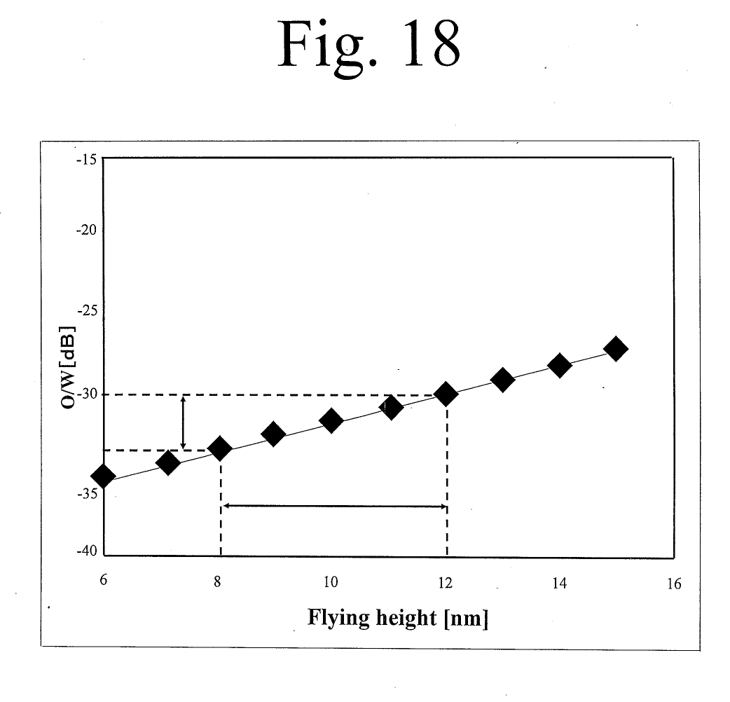

In Step S206, the write check is carried out. The write check is carried out by writing data of certain frequency fa to the magnetic disk by the write head of the magnetic head 126 at first. Then, a level Vfa of the data of frequency fa is obtained by a harmonic sensor of the RDC 113 for example. Further, data of different frequency fb is written from the state in which the data of frequency of fa has been written. Next, a level Vfa′ of the data of frequency fa is measured. Finally, a rate of Vfa and Vfa′ is calculated as the overwrite characteristic. The overwrite characteristic correlates with the levitation value of the magnetic head. FIG. 18 shows the corresponding relationship of the overwrite characteristic and the levitation value. This write check is carried out to each sector of each track. When the write check has been carried out to all of the sectors, the process shifts to Step S207 to prepare corresponding information of a sensor in a certain track and the overwrite characteristic. FIG. 16 shows the corresponding information of the overwrite characteristic and the sector in the certain track. The process then shifts to Step S208. The process in Step S208 will be explained below in detail by using FIG. 17.

### Second Detailed Flow of Process for Preparing Table:

In Step SB01, a minimum value of the overwrite characteristic is found from the corresponding information created in Step S207. It is noted that the levitation value of the magnetic head when the overwrite characteristic is minimum is a reference levitation value. Then, the process shifts to Step SB02.

In Step SB02, it is judged whether or not a differential value between the value of overwrite characteristic and the minimum value of the overwrite characteristic found in Step SB01 has been calculated in all of the sectors. When the differential value has been calculated in all of the sectors the process shifts to Step S203 in FIG. 15. When the differential value has not been carried out for all of the sectors on the other hand, the process shifts to Step SB03.

In Step SB03, a differential value between the value of overwrite characteristic of a certain sector and the minimum value of the overwrite characteristic found in Step SB01 is calculated. It is noted that the calculation of the differential value may be carried out in order from a sector whose number is small. Then, the process shifts to Step SB04.

In Step SB04, a required levitation value in the certain sector is found from the differential value of the overwrite characteristic calculated in Step SB01 and the corresponding relationship between the overwrite characteristic and the levitation value shown in FIG. 18. The minimum value of the overwrite characteristic is “−33” in FIG. 16 for example. Assume now to calculate a difference with a sector whose overwrite characteristic is “−30”. The levitation values corresponding to overwrite characteristics of “−33” and “−30” are “8.0” and “12.0”, respectively, in FIG. 18. The difference of required levitation value is “4.0”. Then, the process shifts to Step SB05.

In Step SB05, a required heater electric power may be found from the required levitation value found in Step SB04 and the corresponding relationship of the expansion value of the magnetic head and the heater electric power explained by using FIG. 5. Here, the difference of the required levitation value is “4.0”, so that the expansion value of the magnetic head to be expanded is found to be “4.0”. Furthermore, the heater electric power necessary for expanding the magnetic head in writing is found to be 25 mW from FIG. 5. The process then shifts to Step SB06.

In Step SB06, a required heater electric current is found from the required heater electric power found in Step SB05 and the corresponding relationship of the heater electric power and the heater electric current explained by using FIG. 4. Because the necessary heater electric power is 25 mW, the heater electric current is 0.45 mA. The process shifts to Step SB07.

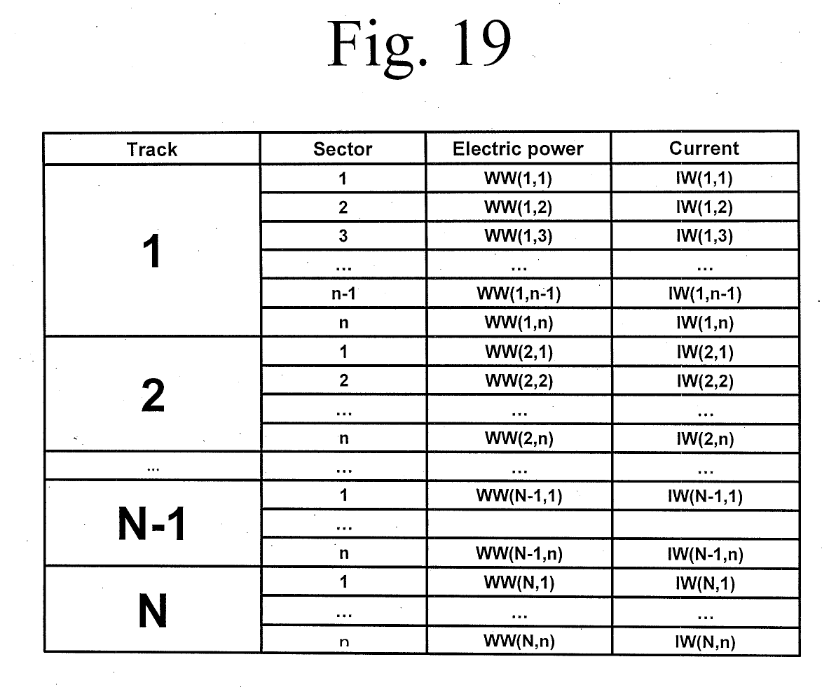

In Step SB07, a table correlating the heater electric current found in Step SB06 and the sector is prepared. FIG. 19 shows the table correlating the heater electric current and the sector. It is found from the table that in the sector m of the track 1 for example, electric current to be supplied to the heat is IW (1, n) and the power is WW (1, n) The process then returns to Step SB02. Thus, the table correlating each sector in a certain track with the heater electric current in each sector may be prepared. When a table correlating a sector and the overwrite characteristic is prepared for a certain track, the process returns to Step S203 to prepare a table for the next track.

When it is judged that the write request has been made from the host unit in the Step S106 explained in the first embodiment by using FIG. 14, the current to be supplied to the heat is controlled based on the table prepared based on the overwrite characteristic. It enables one to control the levitation value corresponding to the information-writing characteristic of the magnetic head to the magnetic disk.

### Third Embodiment

A case of controlling the levitation value based on the error rate evaluating the read performance in reading will be explained in a third embodiment.

While the read check explained in Step S006 in FIG. 10 in the first embodiment is different in the third embodiment, the other processes are the same, so that their explanation will be omitted here.

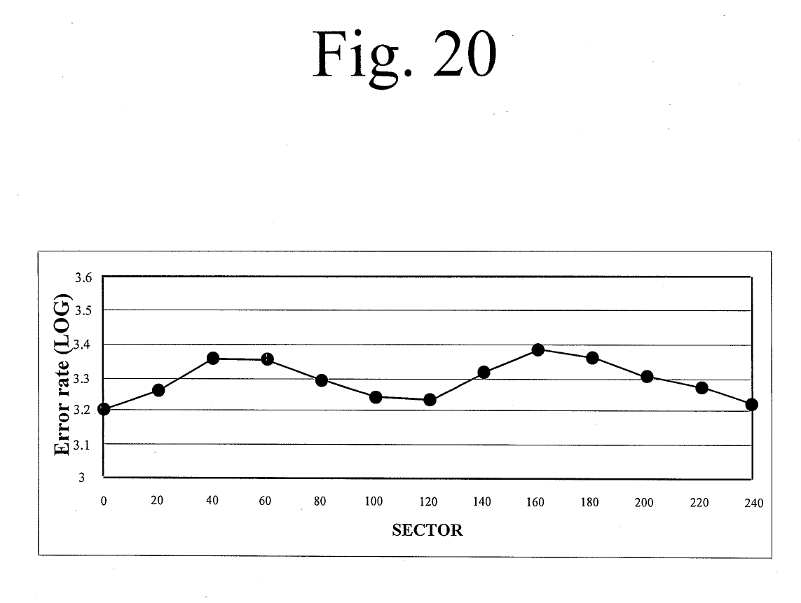

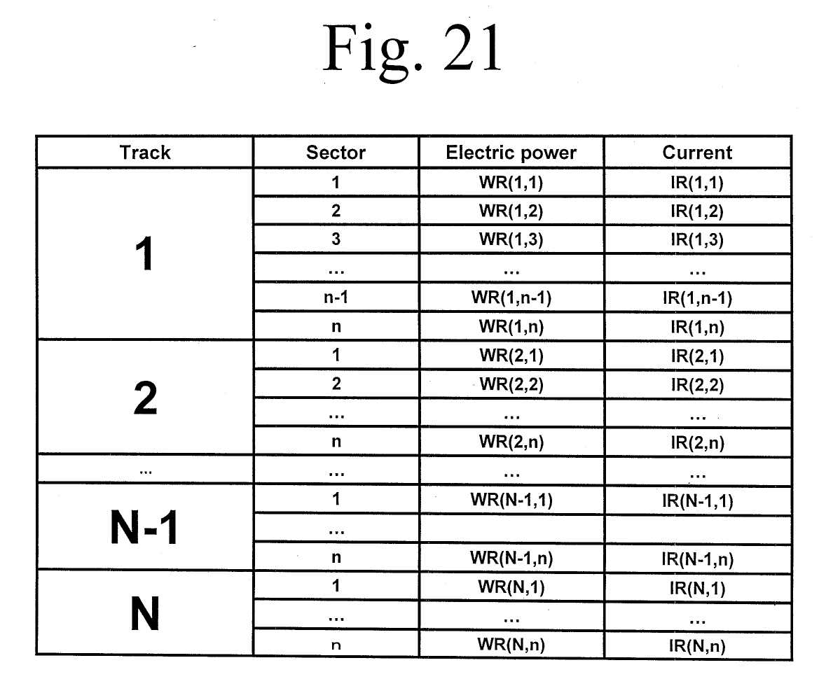

The read check of the present embodiment is carried out by reading a servo frame written in advance to the magnetic disk by the read head of the magnetic head. This read check is carried out to a sector of each track to which the servo frame has been written. When the read check has been carried out for all of the sectors to which the servo frame had been written, corresponding information of the sector of a certain track to which the servo frame has been written with the error rate is prepared. FIG. 20 shows the corresponding information of the sector to which the servo frame has been written and the error rate. As shown in FIG. 20, the error rate is plotted per 20 sectors because the servo frame is formed per 20 sectors for example. Then, the corresponding information of the sector in a certain track and the error rate is prepared by linearly approximating the error rates of the sectors between the servo frames. The table based on the error rate calculated by reading the servo frames may be prepared by carrying out the processes explained in FIG. 10 based on the corresponding information thus prepared. FIG. 21 shows the table. It is apparent from FIG. 21 that in a sector 1 in a track N−1, the current to be supplied to the heater is IR (N−1, 1) and the power is WR(N−1, 1).

When it is judged that a read request has been made by the host unit in Step S106 explained in FIG. 14 in the first embodiment, the current to be supplied to the heater is controlled based on the table prepared based on the error rates calculated by reading the servo frames. It enables one to control the levitation value corresponding to the information reading characteristics of the magnetic head to the magnetic disk in reading.

The embodiments described above do not limit other modes. Accordingly, they may be modified within a scope not changing the subject matters. For example, although the heater has been used as the levitation value control section in the present embodiment, a piezoelectric element may be used. Furthermore, although the table correlating the heater electric current and the sector for all of the tracks of the magnetic disk has been prepared in the embodiments, it is possible to prepare a table correlating the heater electric current and the sector for a certain zone that is an aggregate of tracks. Still more, it is possible to prepare a table correlating the heater electric current with an arbitrary number of sectors by preparing a table correlating the heater electric current and three consecutive sectors for example.

According to the present embodiments, it is possible to improve the writing and reading performances and to increase the density more to improve the storage capacity by controlling the levitation value of the head accurately by considering the magnetic characteristics of the magnetic storage medium.

What is claimed is:

1. A magnetic device comprising:
a head for writing data into or reading data from a medium, the head having an actuator for changing a flying height of the head over the medium;
a storage for storing characteristic information of areas of the medium; and
a controller for controlling the actuator on the basis of the characteristic information of the areas of the medium when writing data into or reading data from the areas of the medium.

2. The magnetic device of claim 1, wherein the characteristic information is a signal to noise ratio obtained from the medium by the head.

3. The magnetic device of claim 2, wherein the controller controls the actuator on the basis of flying height information of the head in association with the signal to noise ratio.

4. The magnetic device of claim 1, wherein the characteristic information comprises flying height information of the head in association with the ratio and expansion value information of the head.

5. The magnetic device of claim 1, wherein the characteristic information is a write performance.

6. The magnetic device of claim 1, wherein the characteristic information is a read performance.

7. A method of controlling a magnetic device having a head for writing data into or reading data from a medium, the head having an actuator for changing a flying height of the head, the method comprising:
storing information of a characteristic of areas of the medium; and
controlling the actuator on the basis of information of the characteristic of the areas of the medium when writing data into or reading data from the medium so as to control the flying height of the head.

8. The method of claim 7, wherein the information of the characteristic is a signal to noise ratio obtained from the medium by the head.

9. The method of claim 8, wherein the controlling controls the actuator on the basis of flying height information of the head in association with the signal to noise ratio.

10. The method of claim 7, wherein the information of the characteristic comprises flying height information of the head in association with the ratio and expansion value information.

11. The method of claim 7, wherein the information of the characteristic is a write performance.

12. The method of claim 7, wherein the information of the characteristic is a read performance.
